(19) United States
(12) Patent Application Publication
(10) Pub. No.: US 2012/0039513 A1
(43) Pub. Date: Feb. 16, 2012

(54) LEVERAGING SOCIAL NETWORKING FOR MEDIA SHARING

(75) Inventors: Sean Patrick Kennedy, San Diego, CA (US); Frederik Carpio, San Diego, CA (US); Michael Chang, San Diego, CA (US); Rommel Garay, San Marcos, CA (US); Paul Jin Hwang, Solana Beach, CA (US); Andrew Lee Lawton, San Marcos, CA (US); Gary Robert Lyons, San Diego, CA (US); Edward Theodore Winter, San Diego, CA (US)

(73) Assignee: SONY CORPORATION

(21) Appl. No.: 12/854,317

(22) Filed: Aug. 11, 2010

(51) Int. Cl. G06K 9/00; G06F 17/30; G06F 3/01

(52) U.S. Cl. 382/118; 715/752; 707/769; 707/E17.014

(57) ABSTRACT

Social media account UIs are disclosed to allow users to easily manage all social media accounts. Photos are automatically shared based on image recognition with social networking contacts appearing in the photos. Movies are automatically created from related social media clips, and videos can be generated by a user and uploaded to the user's social media accounts with a single click.

### FIELD OF THE INVENTION

The present application relates generally to leveraging social networking for media sharing.

### BACKGROUND OF THE INVENTION

“Social media” is term that encompasses an Internet subset: websites that primarily allow users to interact with each other in a variety of ways. Well known social media sites include Facebook®, Twitter®, and MySpace®. Such sites have met with success: more than four in five US online adults now participate in or consume social media at least once a month. Almost one-quarter of U.S. online adults are creators, i.e., people who write blogs, upload original audio or video, or post stories online.

In many social media sites one user may share content with other users, typically by uploading the content to a content storage site and then have friends and family download it manually. As understood herein, this paradigm can be improved. Furthermore, present principles recognize a need to better enable users to manage their various social networking accounts in an integrated fashion.

### SUMMARY OF THE INVENTION

Accordingly, a computing device includes a processor and a video display controlled by the processor. The processor presents on the video display a user interface (UI) to enable a user to manage social networking services and contacts in a single screen. The UI includes a social networking services pane listing the user's social networking sites and selectors enabling a user to add and remove social networking sites from the social networking services pane. The UI also includes a message pane into which messages can be typed and posted to one or more contacts. A contact pane is also provided listing social networking contacts of the user across all social networking sites in the social networking services pane. In some embodiments the processor notes social networking sites visited by the user and adds those sites to a list that may be accessed by appropriately manipulating a selector element

In example embodiments the UI includes a “post” selectable to cause a message in the message pane to be posted to a contact and/or social networking site and an “invite” selector selectable to invite a contact in the contact pane to chat.

In some implementations a second UI can be presented enabling a user to visualize, in a single screen, social networking contacts, the second UI including, for at least a first contact, a selector to view the first contact's latest posts. A selector can also be provided to view the contact's recent uploads and another selector may be provided to view the contact's preferences.

If desired, the second UI may include an identification of a social networking site affiliated with each contact. The second UI can include first and second content panes respectively indicating to the user the contact the user can access from local storage media and from the user's social networking sites. Content from either pane is selectable to send a user-designated group of contacts.

In another aspect, a computing device includes a processor and a video display controlled by the processor. The processor executes logic including receiving a test photograph which includes an image of at least one human face. The logic includes receiving comparison photographs from a social networking site with which the user is affiliated and from a local storage device, and comparing the test photograph with the comparison photographs to determine if the image in the test photograph matches images in the comparison photographs. Responsive to a determination that the image in the test photograph matches an image in at least a first comparison photograph the processor automatically sends the test photograph to the user whose image appears in the test photograph.

In another aspect, a computing device includes a processor and a video display controlled by the processor. The processor generates a movie from plural video clips by receiving input of key words including at least one name of a person and searching at least a local data store for video tagged in metadata with the keywords. Social media sites and indeed the entire Web also may be searched. The processor automatically builds a movie using video clips associated with metadata matching the keywords.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing interior components of the computer;

FIG. 2 is a screen shot of an example user interface (UI) allowing a user to manage content and social networking site information;

FIG. 3 is a screen shot of an example UI allowing a user to establish and maintain content and contact lists;

FIG. 4 is a flow chart of example logic for uploading photographs based on face recognition;

FIG. 5 is a flow chart of example logic for creating a movie from clips from social networking sites; and

FIG. 6 is a screen shot of an example UI for setting up quick video generation and upload.

### DETAILED DESCRIPTION OF THE PREFERRED EMBODIMENT

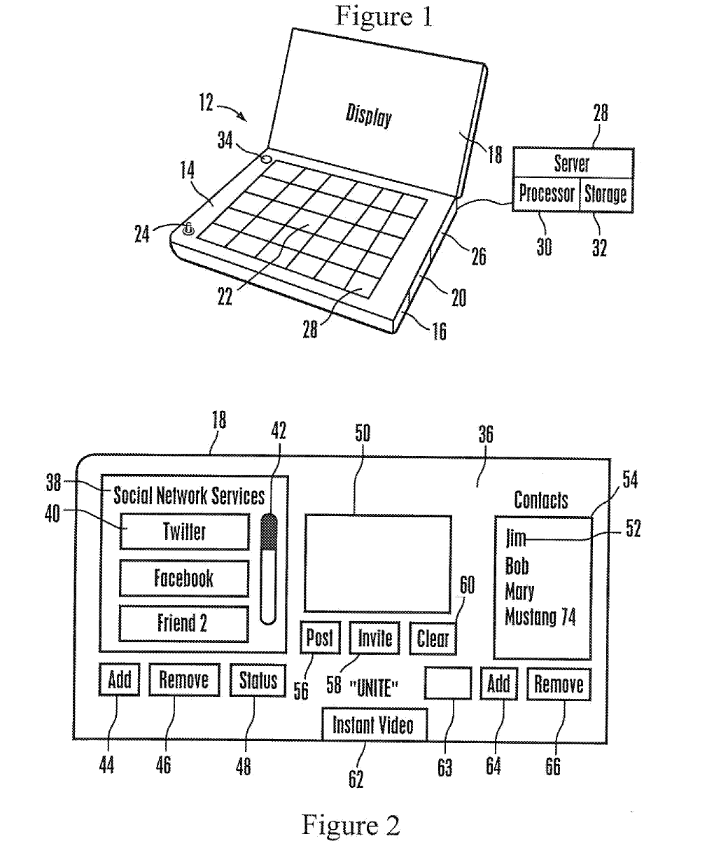

Referring initially to FIG. 1, a computing device 12 such as a personal digital assistant laptop computer, personal computer (PC), etc. includes a housing 14 bearing a digital processor 16. The processor 16 can control a visual display 18 and an audible display such as one or more speakers. The processor 16 may access a media player module such that the device 12 has media decoding capability.

To undertake present principles, the processor 16 may access one or more computer readable storage media 20 such as but not limited to RAM-based storage, a chip implementing dynamic random access memory (DRAM)) or flash memory or disk storage. Software code implementing present logic executable by the device 12 may be stored on one of the memories shown to undertake present principles.

The processor 16 can receive user input signals from various input devices, including a keyboard or keypad 22 (hereinafter “keypad” without loss of generality), a point and click device such as a mouse or joystick 24, etc. A network interface 26 such as a wired or wireless modem or wireless telephony transceiver may also be provided and may communicate with the processor 16 so that information can be exchanged between the computer and one or more servers 28, including social networking servers, on the Internet. A server 28 typically includes one or more server processors 30 and one or more server storage devices 32.

In some implementations, the device 12 may be provided with a video camera 34. Or, the camera 34 may be provided separately from the device 12 and plugged into the device 12 to download video and photos into the device.

FIG. 2 shows an example UI 36 that can be presented on the display 18 by the processor 16 to enable a user to manage his social networking services and contacts in a single screen. As shown, the UI 36 includes a social networking services pane 38 which lists the user's social networking sites 40. In one embodiment the processor 16 notes the sites visited by the user and adds those sites to a drop-down list that may be accessed by appropriately manipulating a selector element such as a slide bar 42. Or, the user can simply type in the name of the site and click an “add” selector 44, and can highlight an entry in the pane 38 using the point and click device 24, for instance, and click on a “remove” selector 46 to remove it. A “status” selector 48 can be selected to present a status of the services in the pane 38 and/or the user's account status of a highlighted entry in the pane 38.

Messages may be typed into a message pane 50 and posted to a highlighted user 52 in a contact pane 54 by selecting a “post” selector 56. A highlighted user in the contact pane 54 can be sent an invitation to, e.g., chat by selecting an “invite” selector 58. The message currently typed into the pane 50 can be deleted by selecting a “clear” selector 60. The contacts in the contact pane 54 may be designated by their online names, with the underlying identifying information of each contact (including status as “friend”, “family”, etc.) being established by the user and maintained in local media 20.

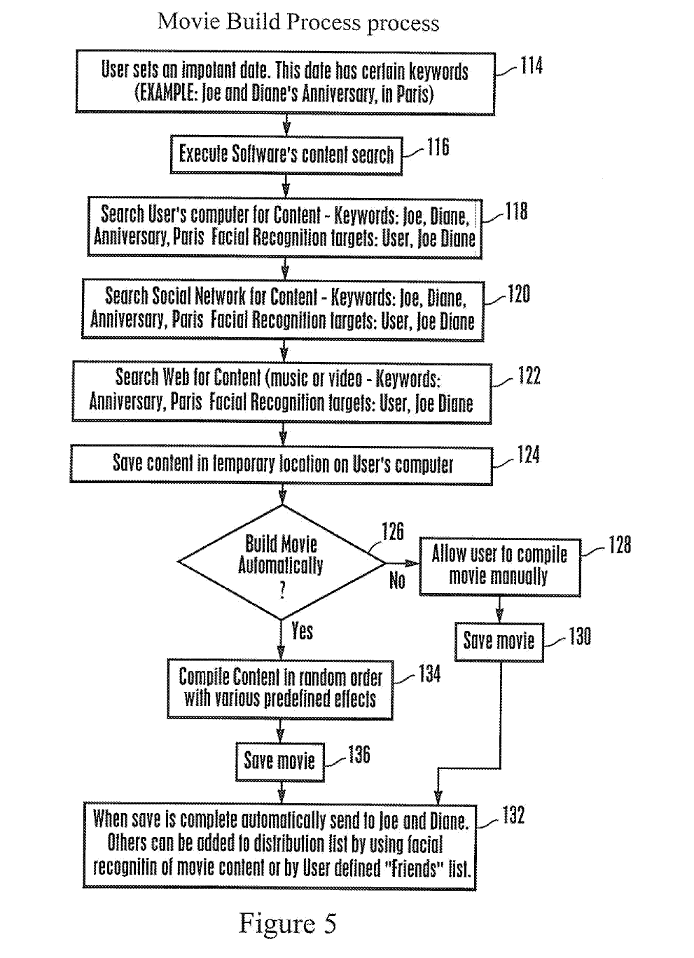

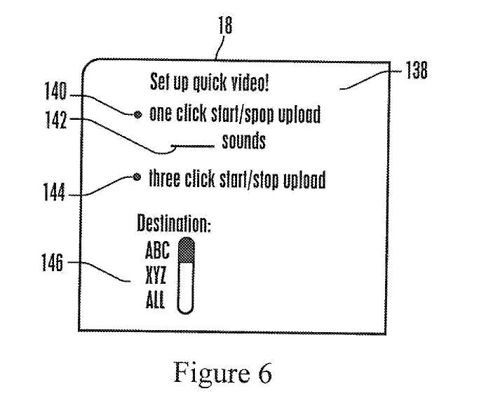

An instant video selector 62 may be provided which, when selected, automatically activates the camera 34 for a predetermined period, e.g., twelve seconds, and then stops the video and uploads it to the user's contacts in the user's social networking sites appearing in the pane 38, either collectively or only to those that the user highlights. Or, the video can be sent to the users appearing in the contact pane 54 collectively or only to those highlighted by the user. Thus, with a single click the user can create a video and send it to all social networking sites/contacts or only to selected sites/contacts. Yet again, the user may elect to execute a three click paradigm in which the first click of the instant video selector 62 starts the camera 34 in generating video, the second click stops it, and the third click uploads the video to the selected sites/contacts. This is described further below with reference to FIG. 6. Still further, a user can select, a “make movie” selector 63 to cause a movie to automatically be generated in accordance with the logic of FIG. 5, discussed further below.

Contacts may be types into the contact pane 54 and added by clicking an “add contact” selector 64, with contacts being removed from the pane 54 by highlighting the contact and selecting a “remove” selector 66. The user can click on an entry to add it to the group of sites shown in the pane 38.

The UI 36 thus allows the user to manage all content for all of his social networking sites at once. Accordingly, instead of having to open ten applications or go to ten different sites, the local UI 36 effectively pushes content and posts to all the various sites, either all at once or one at a time. The UI 36 thus saves time.

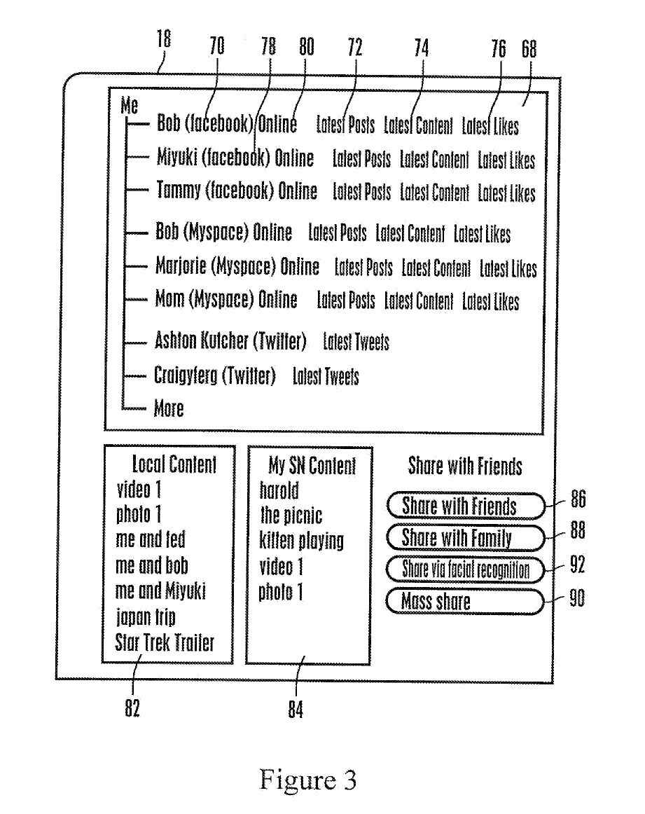

FIG. 3 shows an example UI 68 that can be presented on the display 18 to enable a user to visualize, in a single screen, his social networking contacts 70 along with selectors for viewing the contact's latest posts 72, multimedia uploads 74, and indicated uploaded preferences 76. By each contact name is the identification 78 of the social networking site at which they are the user's contact, as well as an indicator 80 indicating whether the contact is currently online or offline.

Content panes 82, 84 respectively indicate to the user the contact the user can access from local storage media 20 and from the user's social networking sites. Content may be selected horn either pane 82, 84 by highlighting the title of the content and then clicking on a selector 86 to send the content to contacts in the contact pane 54 of FIG. 2 who have been designated as “friends” or by clicking on a selector 88 to send the content to contacts who have been designated as “family”. Yet again, selected content may be sent to all sites/contacts of the user by clicking a “mass share” selector 90.

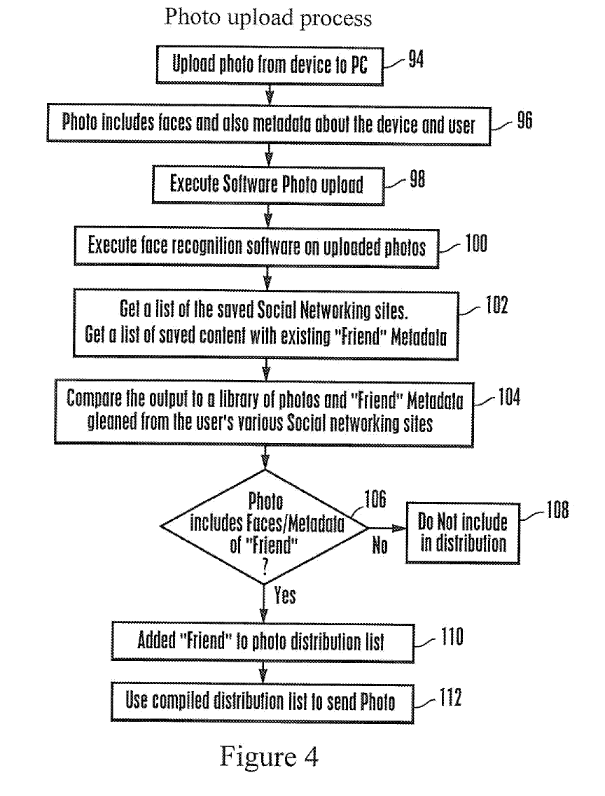

As shown in FIG. 3, a user may also click on a “share via facial recognition” selector 92. This invokes the logic of FIG. 4, some of which is executed before clicking on the selector 92. In any case, together the UIs 36 and 68 helps the user to configure social networking features, and gives the user a centralized one-stop interface for sending messages, uploading pictures, uploading video, sending tweets, etc. The UIs 36 and 68 function as a social networking site status manager for self/friend management. The UI 68 moreover provides a quick social networking site status manager, self/friend management, friend tree management, etc., with all the data for all linked individuals and content being in one location regardless of the social networking sites themselves.

Commencing at block 94 of FIG. 4, a photo is sent to the media 20 from the camera 34, either internally housed or externally housed. Block 96 simply indicates that the photo includes people's faces as well as metadata about the people, typically added to the photo file by the user, and metadata about the device capturing the photo, such as device type, model, make, serial number, and photo settings.

Block 98 indicates that software photo upload to the processor 16 for consideration is executed for executing a face recognition algorithm on the photo under test at block 100. Any suitable face recognition algorithm may be used. At block 102, a list of the user's social network sites (from, e.g., the list composing the entries in the site pane 38 of FIG. 2) is obtained along with a list of saved local content, such as photos, and metadata on contacts designated as “friends” (or “family” or other desired designation).

The output of the face recognition algorithm, is compared at block 104 to facial feature information in a library of photos and “friend” metadata. The library, it may now be appreciated, is created from the lists obtained at block 102. If, at decision block 106, the processor 16 determines that the photo does not match any photos in the library, the process ends at block 108 by not distributing the photo any further. On the other hand, if the processor 16 determines that the photo matches one or more photos in the library, the identity of the friend corresponding to the match(es) from the library as indicated by the friend metadata is added to a distribution list at block 110. The photo is ten uploaded at block 112 to the network address of all friends corresponding to the match(es) from the library.

FIG. 5 shows how a movie can automatically be created to celebrate key milestones learned from social networking sites for individuals. The logic of FIG. 5 may be entered by a user selecting the make movie selector 63 in FIG. 2. Commencing at block 114, the user establishes a desired date using keywords, such as “birthday” “anniversary”, etc., along with, if desired, the names of people associated with the date A software search is commenced at block 116 wherein at block 118 the device 12 is searched for multimedia content tagged (in, e.g., metadata) with the keywords identified at block 114. Also, multimedia content is searched using face recognition techniques for people having names entered into the keywords at block 114. A similar search for matching content from the user's social networking sites is executed at block 120 and if desired the Web can be crawled at block 122 to execute a similar search. Matching content from the local storage 20 identified at block 118, the user's social networking sites identified at block 120, and the remainder of the web (when block 122 is implemented) is stored at block 124.

At block 126, it is determined whether the user has entered a command to build a movie automatically, e.g., in response to an onscreen prompt that the movie match search is complete and to indicate whether to automatically build a movie or manually build a movie. If manual build is selected the logic flows to block 128 to allow the user to compile a movie manually from the search results. This can be done by presenting on the display 18 a thumbnail of each piece of content stored at block 124 and allowing a user to click on a thumbnail to play a portion of the underlying video. A “select” command for a particular clip to be added to the movie may be entered responsive to a prompt or simply by clicking an enter key or other means. In any case, when the user indicates he is finished the movie, compiled from video clips underlying the thumbnails, is saved at block 130. Then, at block 132 the movie is sent automatically to people whose names were entered at block 114. This can be done by sending the movie to their network addresses. Also, the movie can be sent to people whose faces were recognized in selected clips and to a user-defined “friends” list as well.

On the other hand, if the user selects to build the movie automatically, the logic flows from block 126 to block 134 to compile the content stored at block 124 in a random order with various predefined effects, e.g., rotation, zoom in/zoom out speed up play, etc. The movie is saved at block 136 and then distributed at block 132 as described above.

As mentioned previously, a user can select to create a quick video and distribute it with a single click or with, e.g., three clicks, and the UI 138 shown in FIG. 6 illustrates an example of how to facilitate this. A one-click prompt 140 can be selected to establish the one-click video generation/distribution feature described above. A user may enter into a field 142 the number of seconds the user desires the video to be generated following a single click of the instant video selector 62, at the elapse of which video generation is complete and the video is distributed as described.

On the other hand, a three click prompt 144 may be selected in which the user establishes that a first click of the instant video selector 62 starts the generation of a video, a second click of the instant video selector 62 terminates video generation, and a third click of the instant video selector 62 distributes the video. A destination selector 146 may be provided listing the names of social networking sites and/or contacts that the user wishes to send the instant videos to. The user can highlight entries of the list, indicating that the instant videos are to be sent to those entries.

Additional features may be provided. For example, a user can be allowed to set a music type/artist through a UI, or the processor 16 may pick the type/artist based on previous listened to-music, since most media players hold such metadata indefinitely. The processor can then use the search strings and/or metadata to compile samples of content for the music type/artist, e.g., sound bytes, music samples, artists pictures, wallpapers, UI skins. The type/artist can then be populated on the local client system in the form of an operating system Theme or UI theme. The “theme” can then be used to populate the user's blog and social networking profiles or shared with others across a LAN or internet.

While the particular LEVERAGING SOCIAL NETWORKING FOR MEDIA SHARING is herein shown and described in detail, it is to be understood that the subject matter which is encompassed by the present invention is limited only by the claims.

What is claimed is:

1. Computing device comprising:
processor;
video display controlled by the processor, the processor presenting on the video display a user interface (UI) to enable a user to manage social networking services and contacts in a single screen, the UI including:
a social networking services pane listing the user's social networking sites, the UI including selectors enabling a user to add and remove social networking sites from the social networking services pane;
a message pane into which messages can be typed and posted to one or more contacts; and
a contact pane listing social networking contacts of the user across all social networking site in the social networking services pane.

2. The device of claim 1, wherein the processor notes social networking sites visited by the user and adds those sites to a list that may be accessed by appropriately manipulating a selector element

3. The device of claim 1, wherein the UI includes a “post” selectable to cause a message in the message pane to be posted to a contact and/or social networking site and an “invite” selector selectable to invite a contact in the contact pane to chat.

4. The device of claim 1, wherein the UI is a first UI and the processor presents on the display a second UI enabling a user to visualize, in a single screen, social networking contacts, the second UI including, for at least a first contact, a selector to view the first contact's latest posts.

5. The device of claim 4, wherein the second UI includes, for at least a second contact, a selector to view the second contact's recent uploads.

6. The device of claim 4, wherein the second UI includes, for at least a second contact, a selector to view the second contact's preferences.

7. The device of claim 4, wherein the second UI includes an identification of a social networking site affiliated with each contact.

8. The device of claim 4, wherein the second UI includes first and second content panes respectively indicating to the user the contact the user can access from local storage media and from the user's social networking sites.

9. The device of claim 8, wherein content from either pane is selectable to send a user-designated group of contacts.

10. Computing device comprising:
processor;
video display controlled by the processor, the processor:
receiving a test photograph, the test photograph including an image of at least one human face;
receiving comparison photographs from at least one social networking site with which the user is affiliated and from at least one local storage device;
comparing the test photograph with the comparison photographs to determine if the image in the test photograph matches images in the comparison photographs; and
responsive to a determination that the image in the test photograph matches an image in at least a first comparison photograph, automatically sending the test photograph to the user whose image appears in the test photograph.

11. The device of claim 10, wherein the processor uses a facial recognition algorithm as part of the comparison of the test photograph with the comparison photographs.

12. The device of claim 10, wherein the test photograph is associated with metadata about people appearing in the test photograph, and the processor uses the metadata to automatically send the test photograph to the user whose image appears in the test photograph.

13. Computing device comprising:
processor;
video display controlled by the processor, the processor generating a movie from plural video clips at least in part by:
receiving input of key words including at least one name of a person;
searching at least a local data store for video tagged in metadata with the keywords; and
automatically building a movie using video clips associated with metadata matching the keywords.

14. The device of claim 13, wherein the processor further determines whether a user has entered a command to build a movie automatically or manually, and executes automatically building a movie responsive to a determination that the user has entered a command to build a movie automatically.

15. The device of claim 14, wherein responsive to a determination that the user has entered a command to build a movie, the processor presents on the displays thumbnails of video clips associated with metadata matching the keywords, the user being enabled to select from the thumbnails, clips underlying the thumbnails being combined by the processor into the movie.

16. The device of claim 13, wherein the processor further searches social networking sites with which the user is affiliated for video tagged in metadata with the keywords.

17. The device of claim 13, wherein the processor further searches the Web for video tagged in metadata with the keywords.

18. The device of claim 13, wherein the movie is sent automatically by the processor to a network address of at least one person whose name is a keyword.

19. The device of claim 13, wherein the processor further searches for video using facial recognition techniques to identify matching videos from which the movie is generated.
